(19) United States
(12) Patent Application Publication
(10) Pub. No.: US 2010/0150288 A1
(43) Pub. Date: Jun. 17, 2010

(54) Synchronization of Low Noise Local Oscillator using Network Connection

(76) Inventors: Miao Zhu, San Jose, CA (US); John C. Eidson, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/336,548

(22) Filed: Dec. 17, 2008

(51) Int. Cl. H04L 7/00

(52) U.S. Cl. 375/356

(57) ABSTRACT

Two or more local-oscillator-equipped instruments connected to a network are disclosed. Among the instruments, one instrument is designated as the master instrument and the rest, slave instruments. A master clock signal generated by the local oscillator of the master instrument is used by the slave instruments, through the network, to discipline their own local oscillators to generate slave clock signals that are synchronized to the master clock signal.

In one embodiment, in the slave instrument, the master clock signal from the master instrument is used as a reference to generate slave clock signals. In another embodiment, the phases of the slave clock signals are adjusted to compensate for the phase difference between the slave clock signals and the master clock signal.

### BACKGROUND

A local oscillator exists in almost every test and measurement instrument. The local oscillator generates a local clock signal. The local clock signal is used in the instrument as an internal frequency reference for generating other signals and/or measuring the incoming signals. A counter that accumulates the number of cycles of the local clock signal can convert the frequency of the local clock signal into a time signal. The time signal can be used to schedule test and measurement events inside the instrument. Although the specific requirements of the local oscillator are determined by the particular instrument; the general characteristics of the local oscillator include low phase noise, low time jitter, low frequency drift, and low sensitivity to the environmental perturbations. There are often situations when two or more instruments need to synchronize their local oscillators to make useful measurements. Many of these instruments are equipped with a reference frequency input port to accept an external reference clock signal for these synchronization purposes. The user is responsible for choosing a master clock signal source to which the instruments are synchronized, for physically connecting all the necessary cables to the proper ports, and for providing buffers or isolation amplifiers in the reference clock signal path, if needed.

Sometimes, a clock signal from the local oscillator of one of the instruments is chosen to be the master clock signal to which the other instruments are synchronized. Typically, the choice of a clock signal as a common frequency/phase reference depends on the quality of the clock signal. For example, for a clock signal to be suitable as a master clock signal, it has to be the most stable among all the clock signals compared, i.e., the clock signal has to have minimum drift and noise. Therefore, a user has to analyze all the clock signals from the instruments to select one to designate as the master clock signal. The local oscillator producing the master clock signal is known as the master oscillator. The instrument housing the master oscillator is known as a master instrument. All other instruments that are synchronized to the master clock signal are known as slave instruments and their local oscillators are known as slave oscillators. The clock signals generated by the slave oscillators are known as slave clock signals. The user must physically connect the master instrument to the slave instrument(s) to properly distribute the master clock signal to all of the slave instruments.

In a typical set up to synchronize a slave instrument to the master instrument, a user has to connect an output clock signal port of the master instrument to an input clock signal port of the slave instrument using a coaxial cable and BNC connectors, through which the master clock signal is transmitted to the slave instrument to synchronize the slave clock signal. In a situation where there are more than one slave instrument to be synchronized, a signal splitter is used to divide the master clock signal into portions that are then distributed to each of the slave instruments. Each slave instrument then uses the portion of the master clock signal to synchronize its slave clock signal. If it is necessary, the user has to compensate the phase difference in the slave clock signal caused by the time delay in transmitting the master clock signal through the coaxial cable connecting the master instrument to the slave instrument. If the choice of the master instrument is changed for some reasons mid-way through synchronization process, the coaxial cables need to be reconnected to the master and slave instruments.

### BRIEF DESCRIPTION OF THE DRAWINGS

FIG. 1 is a block diagram showing a master instrument connecting to a slave instruments via a network.

FIG. 2 is a schematic diagram showing according to one embodiment, details of a master instrument and a slave instrument from FIG. 1.

FIGS. 3A and 3B are parts of a flowchart showing a method in accordance with an embodiment of the invention.

### DETAILED DESCRIPTION

Most modern instruments are now equipped with network connection, e.g., Ethernet connection. The instruments make use of the network connection to exchange data with one another. In one embodiment of the invention, the network connection just described is utilized to connect the slave instruments to the master instrument. In the embodiment, the master instrument uses its master clock signal to generate a network clock, which determines the rate at which the data is transmitted throughout the network connection as a network signal. Slave instruments connected to the network connection recovers the network clock from the network signal and uses the recovered network clock to do two things; first, to recover the data that is transmitted through the network connection and second, to discipline its slave oscillators to generate slave clock signals that are substantially synchronized to the master clock signal. The advantage of using the network connection is that the master instrument and slave instruments can make use of the existing network connection to synchronize their respective clock signals without having to rely on separate BNC/coaxial cables. Moreover, if the choice of the master instrument is changed mid-way during synchronization, several network control instructions can be implemented in software without the need to re-connect the network connections. One example of a network connection used in an embodiment of the invention is the Gigabit Ethernet (1000BASE-T) because it is a popular network used in test and measurement instruments. The citation of Gigabit Ethernet is not limiting the choice of network connection to apply to the invention. The invention can be implemented in any network that uses a continuous signaling system, in which, in the absence of data, idle symbols, which are defined by the network protocol, are transmitted.

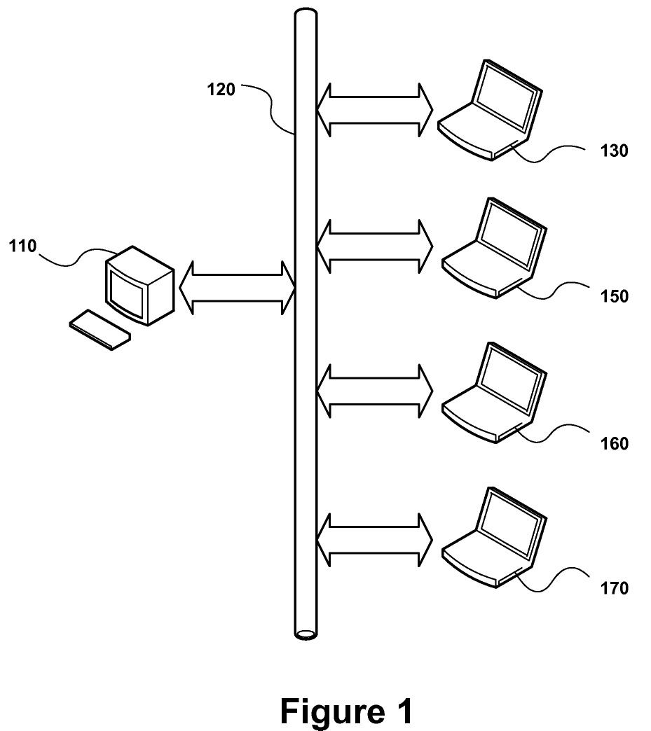

FIG. 1 is a block diagram showing an example of a master instrument 110 connected to the slave instruments 130, 150, 160 and 170 via a network 120, in accordance with an embodiment of the invention. Examples of master instrument 110 and slave instruments 130-170 used in the embodiment include, but are not limited to, digital multimeter and microwave spectral-analyzers. Additionally, the master instrument 110 and slave instruments 130-170 need not be the same instruments. For example, master instrument 110 can be a digital multimeter and slave instrument 130 can be a microwave spectrum analyzer.

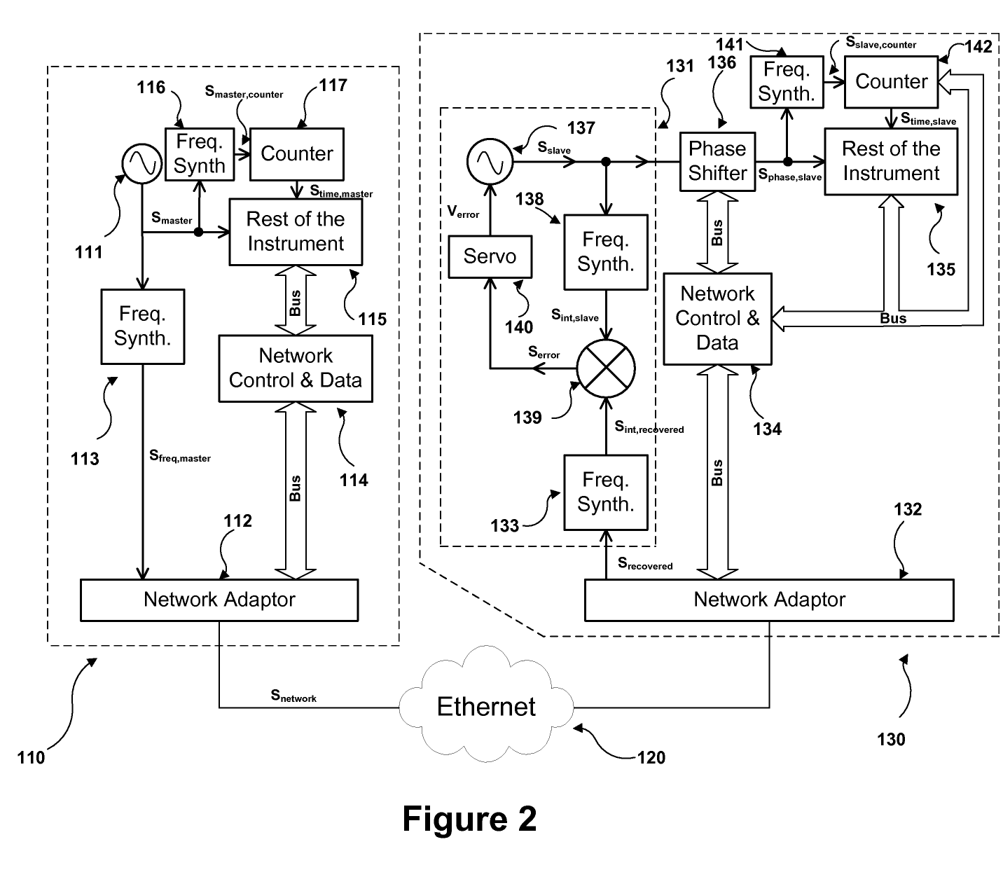

FIG. 2 is a schematic diagram showing, according to one embodiment, details of the master instrument 110 and an exemplary slave instrument 130 of FIG. 1, connected to each other by the network 120. The other slave instruments 150, 160, and 170 of FIG. 1 are omitted in FIG. 2 for the sake of simplicity. Master instrument 110 generates a master clock signal Sₘₐₛₜₑᵣ and data. The master clock signal Sₘₐₛₜₑᵣ is used to generate a network clock S_{clock} (not shown in FIG. 2) that determines the data transmitting rate on network 120. Master instrument 110 transmits the data onto network 120 as a network signal S_{network} at a rate determined by the network clock S_{clock}. Network 120 is a medium providing the connection between master instrument 110 and slave instrument 130. The protocol for network 120 includes a continuous signaling system. The network signal S_{network} travels through network 120 to slave instrument 130. Slave instrument 130 then operates to recover the network clock S_{clock} and the data from the network signal S_{network}. The network clock S_{clock} is recovered as a recovered network clock S_{recovered}. The recovered network clock S_{recovered} is then used by slave instrument 130 to synchronize its own slave clock signal Sₛₗₐᵥₑ to the master clock signal Sₘₐₛₜₑᵣ of master instrument 110.

The master instrument 110 will now be described in greater detail. The master instrument 110 includes a master oscillator 111, a network adaptor 112, a frequency synthesizer 113, a network control and data processor 114 and a box 115 which represents the rest of the instrument. In a further description, the master instrument 110 additionally includes another frequency synthesizer 116 and a counter 117.

Master oscillator 111 is a local oscillator that generates a master clock signal Sₘₐₛₜₑᵣ which is used by the master instrument 110 for a number of purposes. For example, the master clock signal Sₘₐₛₜₑᵣ can be used as an internal reference frequency to generate a microwave signal inside the rest of the instrument 115. In the description where the master instrument 110 additionally includes a counter 117 connected to the master oscillator 111, counter 117 accumulates the number of cycles of the master clock signal Sₘₐₛₜₑᵣ it receives to generate a master time signal S_{time,master} which is used as a time reference to schedule operations within the master instrument 110. Optionally, frequency synthesizer 116 is connected between the master oscillator 111 and counter 117 to receive the master clock signal Sₘₐₛₜₑᵣ to generate an intermediate frequency S_{master,counter} to apply to counter 117. Counter 117 uses the intermediate frequency S_{master,counter} to generate the master time signal S_{time,master}. Typically, for the master clock signal Sₘₐₛₜₑᵣ to be used as a reference signal by other instruments, the master clock signal Sₘₐₛₜₑᵣ has to be stable, i.e., with low drift rate and low phase noise. The stability of the master clock signal Sₘₐₛₜₑᵣ is necessary to avoid causing excessive fluctuations in the clocks of the other instruments synchronized to the master clock signal Sₘₐₛₜₑᵣ. An example of a local oscillator suitable for use as master oscillator 111 is a high quality oven-controlled quartz crystal oscillator.

Frequency synthesizer 113 receives the master clock signal Sₘₐₛₜₑᵣ from master oscillator 111 and generates a frequency-adjusted master clock signal S_{freq,master} which matches the network data transmitting rate defined by the protocol for the network 120. Examples of frequency operations that can be executed by frequency synthesizer 113 include frequency multiplication, frequency division, frequency adding or subtracting, direct digital frequency synthesis, etc. The amount of frequency change to be made will depend on the network data transmitting rate defined by the protocol of network 120 and the frequency of the master clock signal Sₘₐₛₜₑᵣ from master oscillator 111. Once generated, the frequency-adjusted master clock signal S_{freq,master} is applied to network adaptor 112.

Network adaptor 112 connects master instrument 110 to network 120.

Besides providing the physical interface to network 120, network adaptor 112 also carries out a number of functions. Network adaptor 112 uses the frequency-adjusted master clock signal S_{freq,master} from frequency synthesizer 113 to generate a network clock S_{clock}, which determines the rate at which data generated within the master instrument 110 is transmitted to network 120 as a network signal S_{network}. Therefore, the network signal S_{network} is transmitted at a rate that is coherent with the master oscillator 111. The network clock S_{clock} is not shown in FIG. 2 because it is a signal internal to the network adaptor 112. The network clock S_{clock} may have the same frequency as the frequency-adjusted master clock signal S_{freq,master}. However, some network adaptors also have internal frequency synthesizers for generating the network clock S_{clock}, so it is also possible that the frequency of the network clock S_{clock} may be different from the frequency of the frequency-adjusted master clock signal S_{freq,master}. In one embodiment, frequency synthesizer 113 is omitted from the master instrument 110, in which case the network adaptor 112 uses the master clock signal Sₘₐₛₜₑᵣ to generate the network clock S_{clock}.

Rest of the instrument 115 is a collective description for the other components that make up master instrument 110. The rest of the instrument 115 is connected to receive the master clock signal Sₘₐₛₜₑᵣ from master oscillator 111 and/or the master time signal S_{time,master} from counter 117. Typically, rest of the instrument 115 uses the master clock signal Sₘₐₛₜₑᵣ as an internal frequency reference and the master time signal S_{time,master} to coordinate the execution of tasks within itself. Network control and data processor 114 coordinates the instruction/data exchange between the rest of instrument 115 and the network adaptor 112. Network control and data processor 114 also generates the data to apply to network adaptor 112 for output to network 120. If no data is generated, network control and data processor 114 outputs idle symbols to network 120.

Network 120 connects slave instrument 130 to master instrument 110. The protocol for network 120 includes a continuous signaling system; that is, in the absence of data from network control and data processor 114, network 120 supports the transmission of the idle symbols it receives from network adaptor 112, at a rate defined by the network clock S_{clock}. For example, Gigabit Ethernet (1000BASE-T) is one network protocol that defines a continuous signaling system. However, other networks can be used so long as the network protocol defines a continuous signaling system. In the example shown in FIG. 2, network 120 provides a conduit for the network signal S_{network} generated by network adaptor 112 to transmit to slave instrument 130.

The slave instrument 130 is also connected to the network 120. The slave instrument 130 includes a phase-lock loop (PLL) 131, a network adaptor 132, a network control and data processor 134, a phase shifter 136, and a box 135 representing the rest of the instrument. The PLL 131 includes a slave oscillator 137, two frequency synthesizers 133 and 138, a phase-frequency detector 139, and a servo-controller 140. In a further description, the slave instrument 130 additionally includes another frequency synthesizer 141 and a counter 142.

Network adaptor 132 connects the slave instrument 130 to network 120 and enables the slave instrument 130 to communicate across the network 120 according to the network protocol. Network adaptor 132 recovers the network clock S_{clock} from the network signal S_{network} in network 120 as a recovered network clock S_{recovered}.

The slave oscillator 137 generates a slave clock signal Sₛₗₐᵥₑ. Typically the slave oscillator 137 is a voltage-controlled oscillator (VCO) or a voltage control quartz crystal oscillator (VCXO). The slave clock signal Sₛₗₐᵥₑ is locked to the recovered network clock S_{recovered} by the PLL 131. However, the slave clock signal Sₛₗₐᵥₑ and the recovered network clock S_{recovered} may have different frequencies, so they should be converted into a similar intermediate frequency for comparison in the PLL 131.

Frequency synthesizer 138 generates an intermediate frequency S_{int, slave} from the slave clock signal Sₛₗₐᵥₑ. Frequency synthesizer 133 generates an intermediate frequency S_{int,recovered} from the recovered network clock S_{recovered}. The intermediate frequencies S_{int,recovered} and S_{int,slave} should be substantially equal. The two intermediate frequencies S_{int,slave} and S_{int,recovered} are compared by the phase-frequency detector 139. The phase-frequency detector 139, which is also called phase-frequency discriminator, phase-frequency comparator, phase/frequency detector, etc., operates in two modes, both of which involve generating an error signal, Sₑᵣᵣₒᵣ from comparing the two intermediate frequencies S_{int,slave} and S_{int,recovered}. In the first mode, the error signal Sₑᵣᵣₒᵣ represents a phase difference between the two intermediate frequencies S_{int,slave} and S_{int,recovered} when the frequencies of intermediate frequencies S_{int,slave} and S_{int,recovered} are the same. In the second mode where the phase-frequency detector 139 compares the frequencies of the two intermediate frequencies S_{int,slave} and S_{int,recovered}, the error signal Sₑᵣᵣₒᵣ represents a frequency difference between the two intermediate frequencies S_{int,slave} and S_{int,recovered}. The sign on the error signal Sₑᵣᵣₒᵣ indicates which one of the intermediate frequencies S_{int,slave} and S_{int,recovered} has a higher frequency. This error signal Sₑᵣᵣₒᵣ is received by servo controller 140. The servo controller 140 converts the error signal Sₑᵣᵣₒᵣ into a voltage signal Vₑᵣᵣₒᵣ to adjust the slave oscillator 137 until intermediate frequency S_{int,slave} is locked to the intermediate frequency S_{int,recovered}. If S_{int,slave} is locked by the PLL 131 to the intermediate frequency S_{int,recovered}, then it follows that the slave clock signal Sₛₗₐᵥₑ will be locked to the recovered network clock S_{recovered}. In one embodiment, the phase-frequency detector 139 is replaced by a phase detector. Additionally, PLL 131 also reduces the phase noise in the recovered network clock S_{recovered}, although other phase noise reduction methods are equally possible.

In one embodiment, frequency synthesizer 138 is omitted from PLL 131, in which case the slave oscillator 137 will generate a slave clock signal Sₛₗₐᵥₑ that has the same frequency as the intermediate frequency S_{int,recovered}. In another embodiment, frequency synthesizer 133 is omitted from PLL 131, in which case the frequency synthesizer 138 generates the intermediate signal S_{int,slave} that has the same frequency as the recovered network clock S_{recovered}. In yet another embodiment, both frequency synthesizers 133 and 138 are omitted in PLL 133 and the frequency of slave clock signal Sₛₗₐᵥₑ is substantially the same as that of the recovered network clock S_{recovered}.

At this point, although the slave clock signal Sₛₗₐᵥₑ is synchronized to the recovered network clock S_{recovered}, the slave clock signal Sₛₗₐᵥₑ is not yet aligned in phase with the master clock signal Sₘₐₛₜₑᵣ, i.e., a phase difference exists between the recovered network clock S_{recovered} and the master clock signal Sₘₐₛₜₑᵣ. This phase difference between the slave clock signal Sₛₗₐᵥₑ and the master clock signal Sₘₐₛₜₑᵣ is due to a number of factors. One of these factors is a finite time delay taken by the network signal S_{network}, which includes network clock S_{clock} and data, to transmit from the master instrument 110 to the slave instrument 130, through network 120.

This phase difference is computed and compensated by the network control and data processor 134 in conjunction with phase shifter 136 in a method to be described later, to synchronize the slave clock signal Sₛₗₐᵥₑ to the master clock signal Sₘₐₛₜₑᵣ.

Phase shifter 136 is another circuit component operable to change the phase of the slave clock signal Sₛₗₐᵥₑ it receives from PLL 131 to generate a phase-adjusted slave clock signal S_{phase,slave} that is synchronized to the master clock signal Sₘₐₛₜₑᵣ. The amount of phase to adjust depends on the instructions the phase shifter 136 receives from the network control and data processor 134 through the internal bus. In one embodiment, the network control and data processor 134 measures the time delay taken by the network signal S_{network} to transmit through network 120 and calculates the corresponding phase difference. The network control and data processor 134 then communicates the phase difference via internal buses to phase shifter 136 to implement the phase change on slave clock signal Sₛₗₐᵥₑ to generate the phase-adjusted slave clock signal S_{phase,slave}. The phase-adjusted slave clock signal S_{phase,slave} is then used in a number of applications similar to those already described for master instrument 110, e.g., as an internal reference frequency to generate a microwave signal inside the rest of the instrument 135. Additionally, the phase-adjusted slave clock signal S_{phase,slave} is also applied to counter 142, in which counter 142 accumulates the number of cycles of the phase-adjusted slave clock signal S_{phase,slave} it receives to generate a slave time signal S_{time,slave}. The slave time signal S_{time,slave} is used by the slave instrument 130 as a reference to schedule operations within itself. Optionally, a frequency synthesizer 141 may be connected between the phase shifter 136 and counter 142. Frequency synthesizer 141 receives the phase-adjusted slave clock signal S_{phase,slave} to generate an intermediate frequency S_{slave,counter} to apply to counter 142 to generate the slave time signal S_{time,slave}.

The method of computing and compensating for the phase difference between the master clock signal Sₘₐₛₜₑᵣ and the slave clock signal Sₛₗₐᵥₑ will now be described. In one embodiment, the method used to measure the phase difference between the slave clock signal Sₛₗₐᵥₑ and the master clock signal Sₘₐₛₜₑᵣ is based on the IEEE 1588 Precision Time Protocol. In IEEE 1588 Precision Time Protocol, the network control and data processor 114 of the master instrument 110 and the network control and data processor 134 of the slave instrument 130 engage in passing of timing information between the two oscillators through network 120 to compute the time delay in transmitting the network signal S_{network} from the master instrument 110 to the slave instrument 130.

After the time delay is computed, the network control and data processor 134 of the slave instrument 130 converts the computed time delay to an equivalent phase difference that has already been described. This phase difference usually has two parts; a first part that is an integer multiple of 2π and a second part that is a fraction of 2π. The network control and data processor 134 communicates the second part of the phase difference (a fraction of 2π) via internal bus to phase shifter 136 to implement the phase change on slave clock signal Sₛₗₐᵥₑ to generate the phase-adjusted slave clock signal S_{phase,slave}. Alternatively, network control and data processor 134 communicates both the first and second parts of the phase difference to phase shifter 136 to implement a phase change of more than 2π on slave clock signal Sₛₗₐᵥₑ to generate the phase-adjusted slave clock signal S_{phase,slave}. Once the phase shift corresponding to the second part of the phase difference is implemented, the resultant phase-adjusted slave clock signal S_{phase,slave} is synchronized to the master clock signal Sₘₐₛₜₑᵣ, i.e., aligned in phase with the master clock signal Sₘₐₛₜₑᵣ where the phase difference with the clock signal Sₘₐₛₜₑᵣ is substantially zero. As for the first part of the phase difference (an integer multiple of 2π), the network control and data processor 134 communicates the first part of the phase difference via internal bus for compensation in counter 142 by changing the contents within by an amount equivalent to the value of the first part.

Alternatively, the value of the first part of the phase difference is used to add to or subtract from a readout of counter 142 (not shown in FIG. 2), without altering the contents of counter 142, to compensate for the first part of the phase difference.

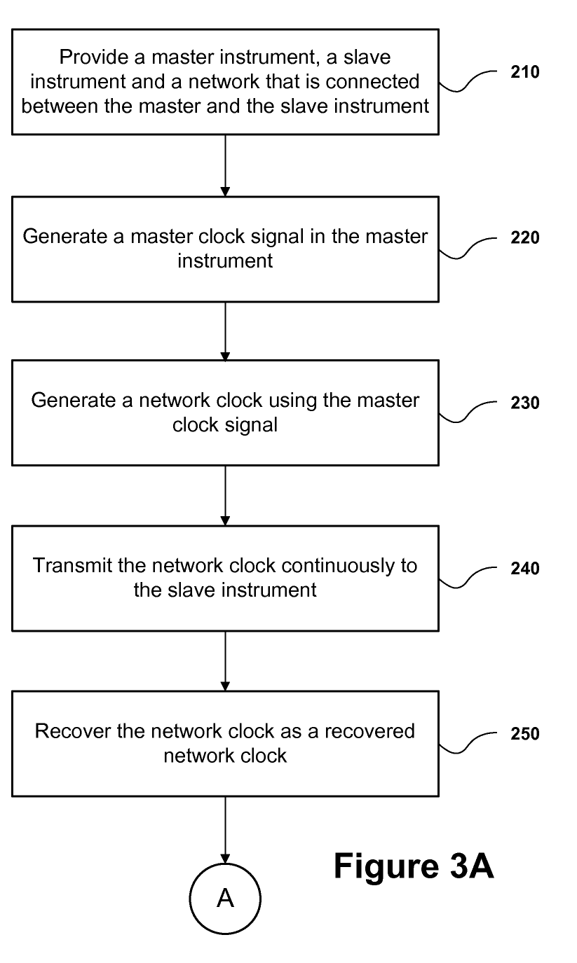

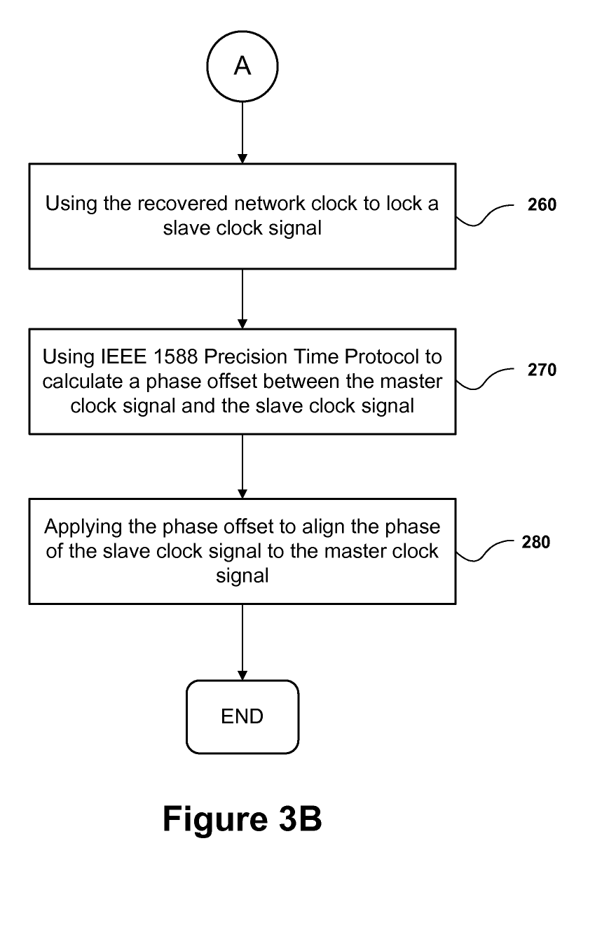

Accordingly, the invention includes a method of synchronizing the clocks of a master instrument and a slave instrument using a network that is connected between the master instrument and the slave instrument. FIGS. 3A and 3B are parts of a flowchart showing a sequence of steps that implements a method in accordance with an embodiment of the invention. In step 210, a master instrument 110, a slave instrument 130 and a network 120 connected between the master instrument 110 and the slave instrument 130 connected, such as those in FIG. 2, are provided.

In step 220, the master instrument generates a master clock signal of a pre-determined frequency and phase.

In step 230, the master clock signal is used to generate a network clock. The network clock defines the rate at which data is transmitted through network 120.

In step 240, the network clock is transmitted continuously to the slave instrument via the network 120 as part of a network signal, which supports a continuous signaling system protocol.

In step 250, the network clock is recovered at the slave instrument as a recovered network clock.

In step 260, a slave clock signal is locked to the recovered network clock.

In step 270, after locking the frequency of the slave clock signal, a phase offset between the slave clock signal and the master clock signal is measured and calculated using the IEEE 1588 Precision Time Protocol that is already described in relation to FIG. 2.

In step 280, the measured and calculated phase offset is applied to the slave clock signal to align the phase of the slave clock signal to the phase of the master clock signal. Once the phase of the salve clock signal is aligned, the slave clock signal is substantially synchronized to the master clock signal.

This disclosure describes the invention in detail using illustrative embodiments. However, the invention defined by the appended claims is not limited to the precise embodiments described.

We claim:

1. A system comprising a master instrument and a slave instrument connected to a network, wherein:
the master instrument comprises:
a master oscillator that generates a master clock signal that is used as an internal frequency reference; and
a first network adapter that generates a network clock from the master clock signal, the network clock determines the data transmission rate in the network; and
the slave instrument comprises:
a slave oscillator that generates a slave clock signal;
a second network adaptor that recovers the network clock from the network as a recovered network clock;
a phase-lock loop (PLL) connected to receive the recovered network clock and lock the slave clock signal to the recovered network clock; and
a phase shifter connected to receive the slave clock signal to generate a phase-adjusted slave clock signal that is substantially synchronized to the master clock signal.

2. The system of claim 1, wherein the network supports a continuous signaling system protocol.

3. The system of claim 1, wherein the PLL comprises:
a phase-frequency detector that compares the slave clock signal and the recovered network clock to generate an error signal; and
a servo controller that uses the error signal received to adjust the frequency of the slave oscillator.

4. The system of claim 3, further including a first frequency synthesizer between the slave oscillator and the phase-frequency detector, the first frequency synthesizer generating a first intermediate frequency from the slave clock signal for comparison by the phase-frequency detector.

5. The system of claim 3, further including a second frequency synthesizer between the second network adaptor and the phase-frequency detector, the second frequency synthesizer generating a second intermediate frequency from the recovered network clock for comparison by the phase-frequency detector.

6. A master instrument for synchronizing a slave instrument through a network, the master instrument comprising:
a master oscillator that generates a master clock signal that is used as an internal frequency reference; and
a network adapter that generates a network clock from the master clock signal, the network clock determines the data transmission rate of the network.

7. The master instrument of claim 6, additionally comprising a frequency synthesizer connected between the master oscillator and the network adaptor, operable to receive the master clock signal from the master oscillator to generate a frequency-adjusted master clock signal to apply to the network adaptor, the frequency of the frequency-adjusted master clock signal determines the data transmission rate.

8. The master instrument of claim 6, additionally comprising a counter connected to receive the master clock signal to generate a master time signal for scheduling operations within the master instrument.

9. The master instrument of claim 8, additionally comprising a frequency synthesizer connected between the master oscillator and the counter, the frequency synthesizer receives the master clock signal to generate an intermediate frequency to apply to the counter.

10. A slave instrument for synchronizing to a master instrument through a network, the slave instrument comprising:
a slave oscillator that generates a slave clock signal;
a network adaptor that recovers a network clock from the network as a recovered network clock;
a phase-lock loop (PLL) that locks the slave clock signal to the recovered network clock; and
a phase shifter connected to receive the slave clock signal to generate a phase-adjusted slave clock signal that is substantially synchronized to a master clock signal in the master instrument.

11. The slave instrument of claim 10, wherein the PLL comprises:
a phase-frequency detector that compares the slave clock signal and the recovered network clock to generate an error signal; and
a servo controller that uses the error signal received to adjust the frequency of the slave oscillator.

12. The slave instrument of claim 10, further including a first frequency synthesizer between the slave oscillator and the phase-frequency detector, the first frequency synthesizer generating a first intermediate frequency from the slave oscillator for comparison by the phase-frequency detector.

13. The slave instrument of claim 10, further including a second frequency synthesizer connected between the network adaptor and the phase-frequency detector, the second frequency synthesizer generating a second intermediate frequency from the recovered network clock for comparison by the phase-frequency detector.

14. The slave instrument of claim 10, additionally includes a counter that receives the phase-adjusted slave clock signal to generate a slave time signal used for scheduling operations within the slave instrument.

15. The slave instrument of claim 14, additionally includes a third frequency synthesizer connected between the phase shifter and the counter, the frequency synthesizer receives the phase-adjusted slave clock signal to generate a third intermediate frequency to apply to the counter.

16. The slave instrument of claim 10, wherein a network control and data processor in the slave instrument uses the IEEE 1588 Precision Time Protocol to measure and to calculate a phase difference between the master clock signal and the slave clock signal to apply to the phase shifter to generate the phase-adjusted slave clock signal, wherein the phase difference between the phase-adjusted slave clock signal and the master clock signal is substantially zero.

17. A method of synchronizing clocks in a master instrument and a slave instrument through a network, comprising:
generating a network clock based on a master clock signal produced by the master instrument, the master clock signal used as an internal frequency reference within the master instrument;
transmitting the network clock through the network to the slave instrument, wherein the network supports a continuous signaling system protocol;
recovering the network clock from the network as a recovered network clock; and
locking a slave clock signal to the recovered network clock.

18. The method of claim 17, further comprising:
aligning the phase of the slave clock signal to that of the master clock signal.

19. The method of claim 18, wherein aligning the phase of the slave clock signal to the master clock signal includes measuring and calculating a phase offset between the master clock signal and the slave clock signal using the IEEE 1588 Precision Time Protocol.

20. The method of claim 17, wherein the slave clock signal and the master clock signal have different frequencies.

21. The method of claim 17, wherein the master clock signal and the network clock have different frequencies.
